(19) United States
(12) Patent Application Publication
(10) Pub. No.: US 2021/0334425 A1
(43) Pub. Date: Oct. 28, 2021

(54) METHOD OF DESIGNING, CONFIGURING AND ACCESSING A MODULAR SELF-STORAGE FACILITY

(71) Applicant: SNL Fund, LLC, New York, NY (US)

(72) Inventor: Marc Sharinn, Cold Spring Harbor, NY (US)

(21) Appl. No.: 17/302,068

(22) Filed: Apr. 22, 2021

Related U.S. Application Data
(60) Provisional application No. 63/013,771, filed on Apr. 22, 2020.
(60) Provisional application No. 63/073,577, filed on Sep. 2, 2020.

(51) Int. Cl. G06F 30/13; G06F 30/17

(52) U.S. Cl. CPC G06F 30/13; G06F 30/17

(57) ABSTRACT

A storage facility and a method of designing, configuring, reconfiguring and accessing a modular self-storage facility that utilizes shipping containers and/or other pre-fabricated portable storage containers that can be arranged next to each other and stacked on top of each other in a way that provides an efficient design and use along with easy access to the facility and units and the ability for consumers to utilize what are in-effect, internal corridors.

### CROSS-REFERENCE TO RELATED APPLICATIONS

This application claims priority to U.S. Provisional Patent Application No. 63/013,771, filed on Apr. 22, 2020, and U.S. Provisional Patent Application No. 63/073,577, filed on Sep. 2, 2020, the contents of each are incorporated herein by reference in their entirety.

### FIELD OF THE INVENTION

The present disclosure is directed generally to storage and more particularly to a method of designing, configuring, reconfiguring and accessing a modular self-storage facility.

### BACKGROUND OF THE INVENTION

First generation self-storage facilities were designed as single-story, row-style, slab-on-grade buildings with unit access doors in front of the unit. Unit renters were able (and for those that still use these storage facilities are able) to drive up to the door of their assigned unit and load and unload desired items into and out of their unit. Unit renters benefited from the ability to unload items from their vehicle in close proximity to their storage unit rental. However, customers were (and for those that still use these storage facilities are) subjected to environmental elements (e.g., snow, rain, extreme heat, etc.) and the overall quality of such units and lighting at such facilities was typically poor.

As the self-storage space began to mature, operators and developers sought to improve the consumer experience and reduce the real estate footprint needed to operate the traditional drive-up self-storage facilities. The space has seen significant development in the form of multi-story, climate-controlled buildings. These buildings regularly include interior unloading/loading areas, key-coded access to interior freight elevators that lead to hallways which provide access to storage units. These second and third generation, self-storage facilities are where most of the design innovation over the past 20 years has been focused and have made up nearly all of the self-storage development in that time frame.

While first generation, drive-up self-storage still exists, these storage facilities have, in many cases, become antiquated in terms of both quality of renter experience as well as design. One of the more recent advancement to improve the quality of the drive-up facility storage model has been in the unit itself. There has been a move away from row-style buildings with foundations towards individual, portable container units. These container units are assembled one-by-one with relative ease and are placed side by side on the ground without a foundation giving the overall appearance of a continuous building. In certain instances, facility operators have repurposed used shipping containers as storage units and similarly arranged as the portable units side-by-side.

While there are benefits of both traditional drive-up facilities (and related portable units and container units) and multi-story storage buildings, there is no facility or system that is a hybrid of the two storage models.

### SUMMARY OF THE INVENTION

The present invention is generally directed to a method of designing, configuring and accessing a self-storage facility that utilizes shipping containers and/or other pre-fabricated portable storage containers that can be arranged next to each other and stacked on top of each other (e.g., from largest to smallest) in a way that provides an efficient design and use along with easy access to the facility and units and the ability for consumers to utilize what are in-effect, internal corridors.

The present invention is scalable and as such adaptable depending on consumer demand. If the demand is high, the storage facility can be scaled up. If the demand is low, the storage facility can be scaled down by relocating the shipping containers to another facility or selling them back into the market. This may alleviate a concern of a municipality who has approval jurisdiction over such facilities. That is, if a facility operator determines to close a facility as a result of lower demand than forecast, a large, multi-story building will be left behind that is not easily re-purposed by a future user. The modularity and scalability of the present invention eliminates that potential concern.

Customers want the well-lit, secure storage that a modern storage facility building offers as well as the ability to drive their vehicle to their storage unit that is offered by drive-up storage facilities. In an embodiment, the present invention allows customers to drive their vehicle to a lift and drop off their items without physically having to carry the items up a flight or flights of stairs and utilize stairs to access the upper floors. The stairs and lift can be interior facing for the upper levels. By turning the second level doors to the interior, contrary to the first level, a secure access hallway on the upper level can be created by utilizing the exterior roof of the lower unit as the floor. This also eliminates the need to build an exterior walkway with a safety railing. In an embodiment, the lift can be operated by an employee of the facility who can assist with loading of storage items and will operate the lift. Alternatively, the lift can be unmanned that is accessed without employee assistance. The upper floors can have carts/dollies which the customers then may use to transport their items to their unit. Alternatively, if a car or truck lift is used, the user may back the car on to the lift and then unload the materials directly on to the upper floor. The storage facility can further include a roof arranged above the uppermost level to protect customers/storage unit owners from the environments (e.g., sun, rain, snow, etc.).

The storage facility can further include an office that is a modular prefabricated custom space that can be made out of a shipping container. It can be designed off site and delivered nearly completed, ready to be installed. Modern automation systems for self-storage operations can be implemented, including online/app-based unit rentals, kiosks which distribute locks and state of the art security, actively monitored by closed-caption television (CCTV). The facilities can also be designed to be eco-friendly, low-energy consuming, utilizing solar power, where possible, and eco-friendly lighting. The roof for each stack is designed for solar as well.

The overall system creates a self-storage product that commoditizes much of the development and construction process. It allows for the engineering, design and the majority of construction to take place offsite, significantly reducing the time it takes to render a facility operational. It creates the ability to have a modular storage facility, rapidly moving from acquisition to operation to meet current demand.

### BRIEF DESCRIPTION OF THE FIGURES

FIG. 1 is an elevation view of a storage facility of the present disclosure according to an embodiment of the present disclosure;

FIG. 2 is a perspective view of a storage facility of the present disclosure according to another embodiment of the present disclosure;

FIGS. 3-10 are various views of a storage facility according to an embodiment of the present disclosure;

FIGS. 11-18 are various views of a storage facility according to another embodiment of the present disclosure;

FIGS. 19-26 are various views of a storage facility according to yet another embodiment of the present disclosure;

FIGS. 27-32D are various views of a storage facility according to another embodiment of the present disclosure;

FIGS. 33-38 are various views of a storage facility according to another embodiment of the present disclosure;

FIGS. 39-44 are various views of a storage facility according to another embodiment of the present disclosure; and

FIGS. 45-49 are various views of a storage facility according to another embodiment of the present disclosure.

### DETAILED DESCRIPTION OF EMBODIMENTS OF THE PRESENT INVENTION

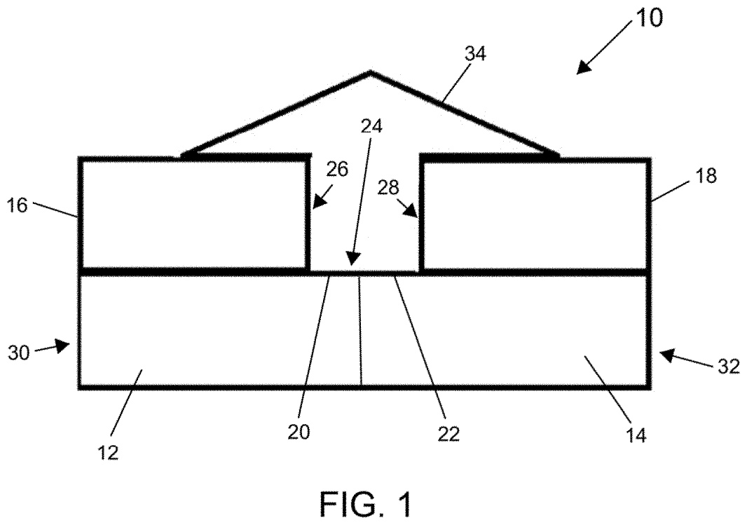

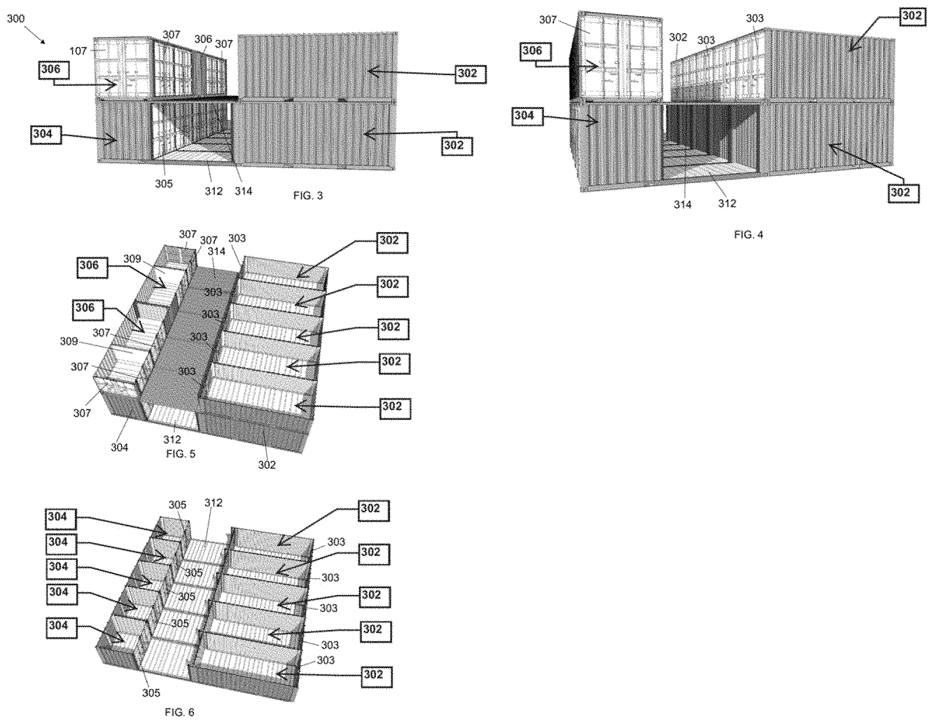

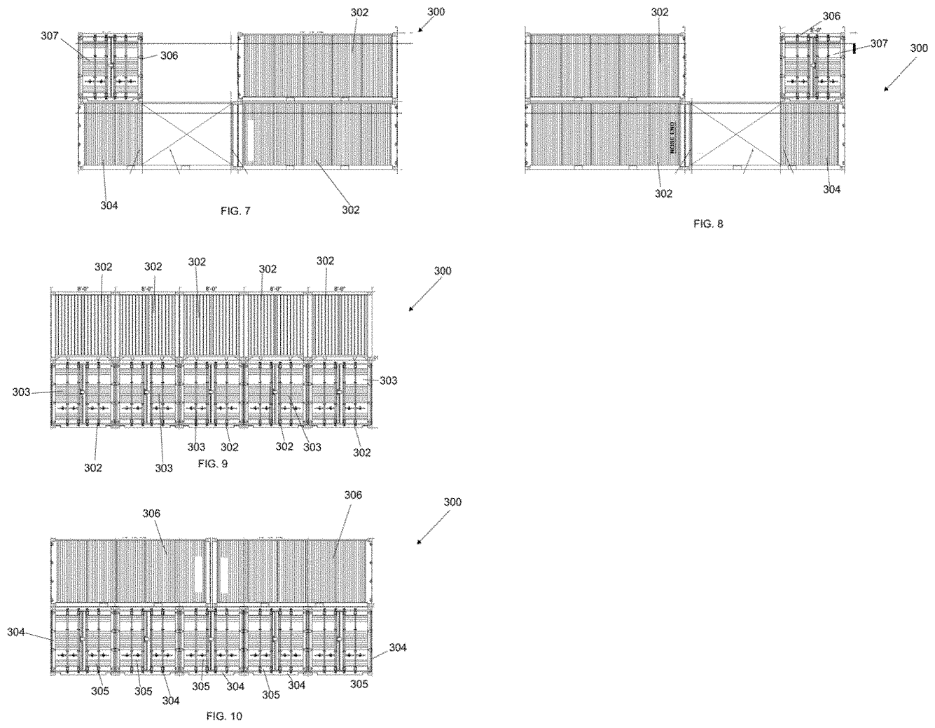

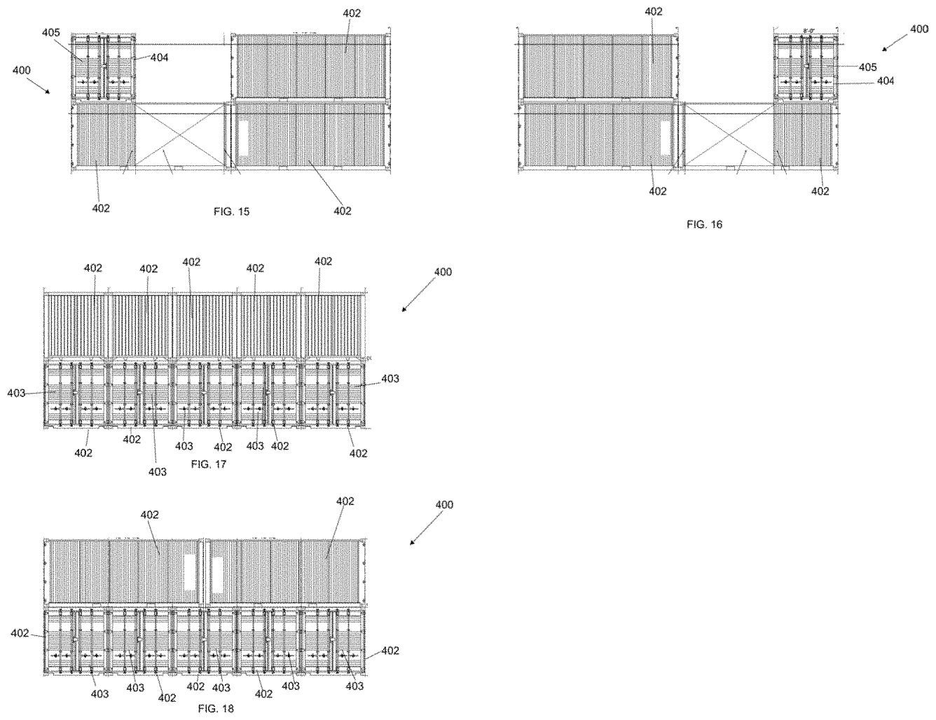

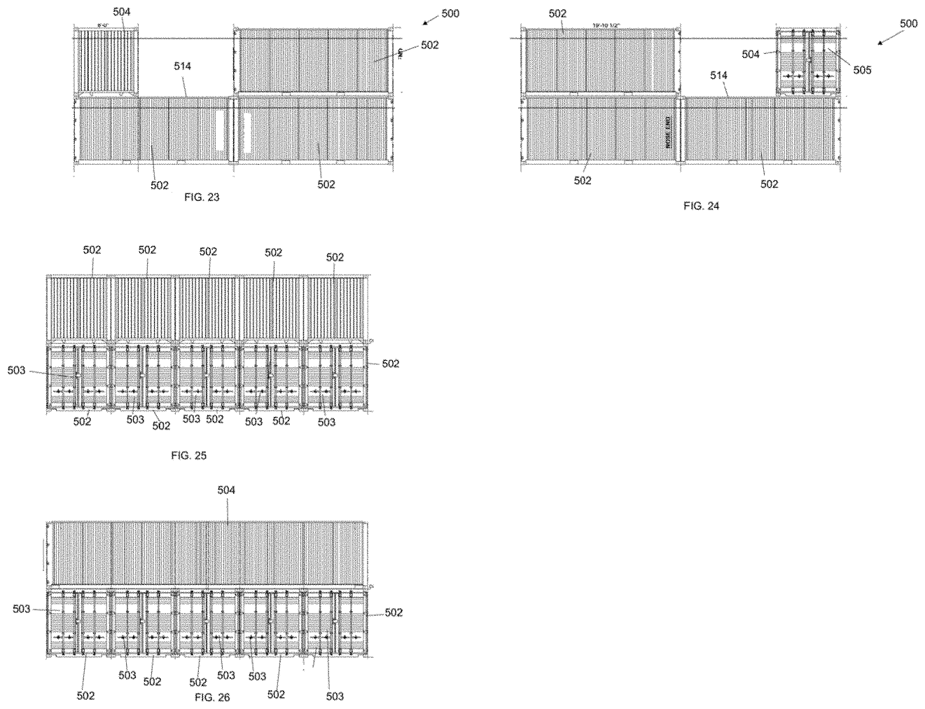

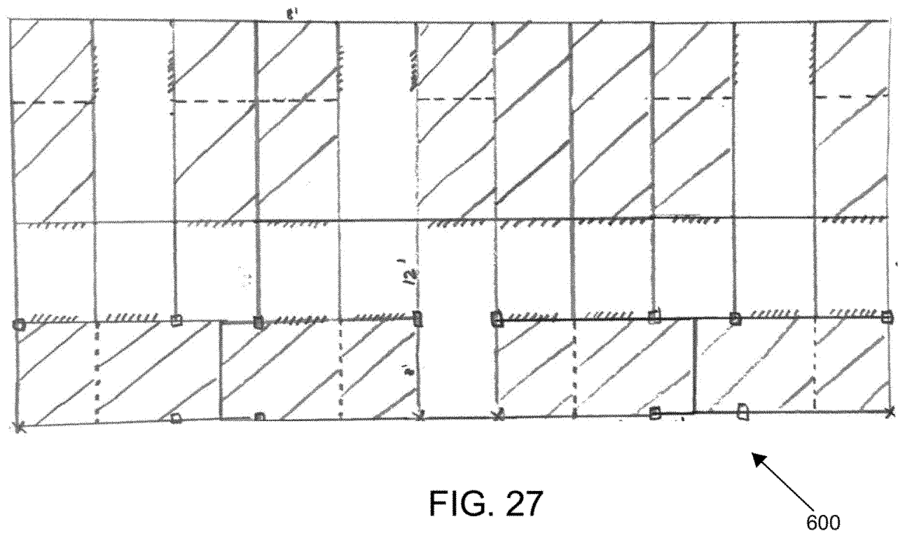

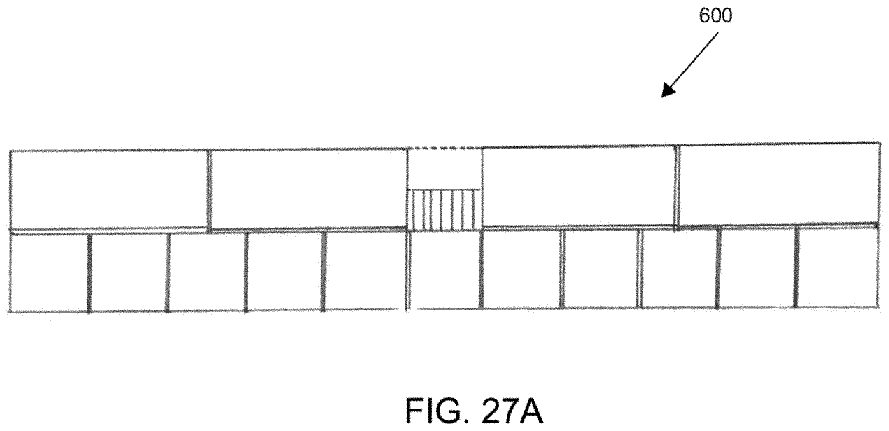

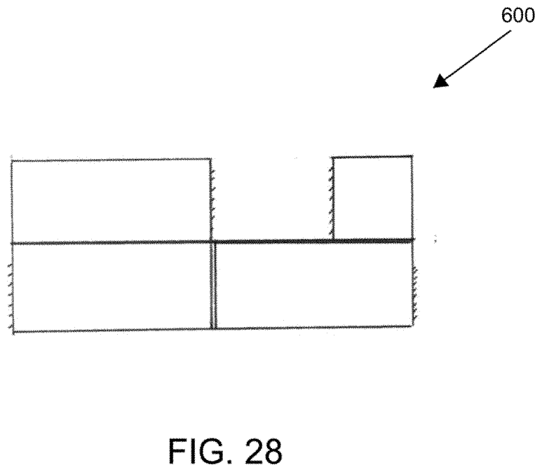

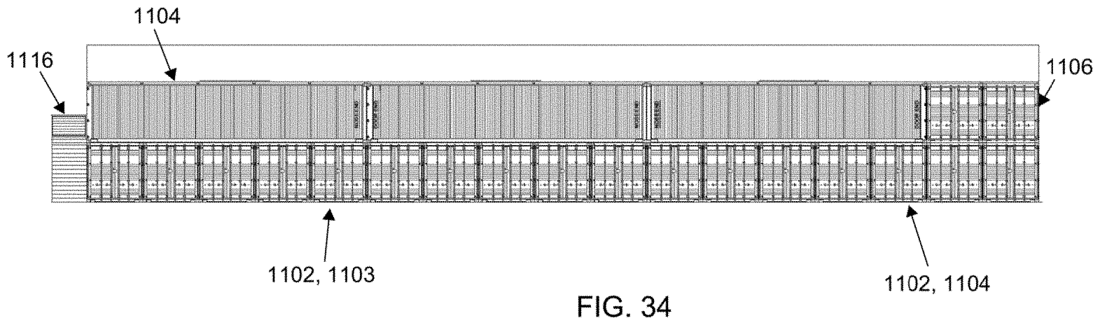

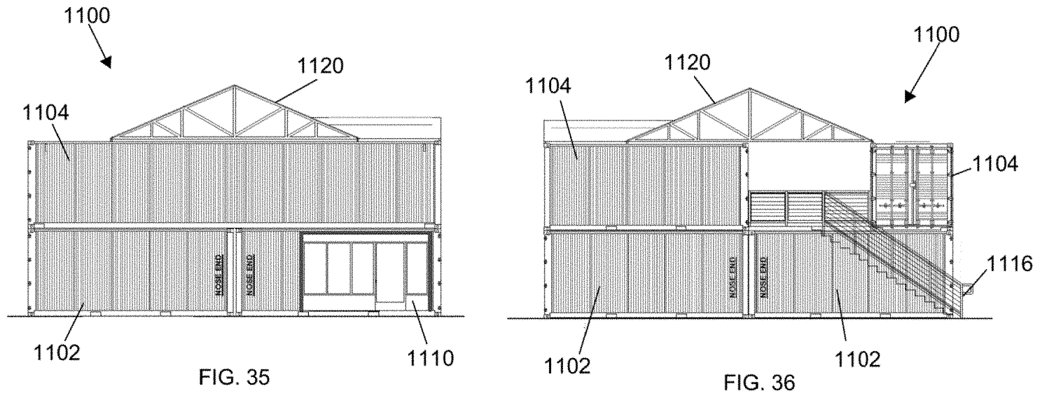

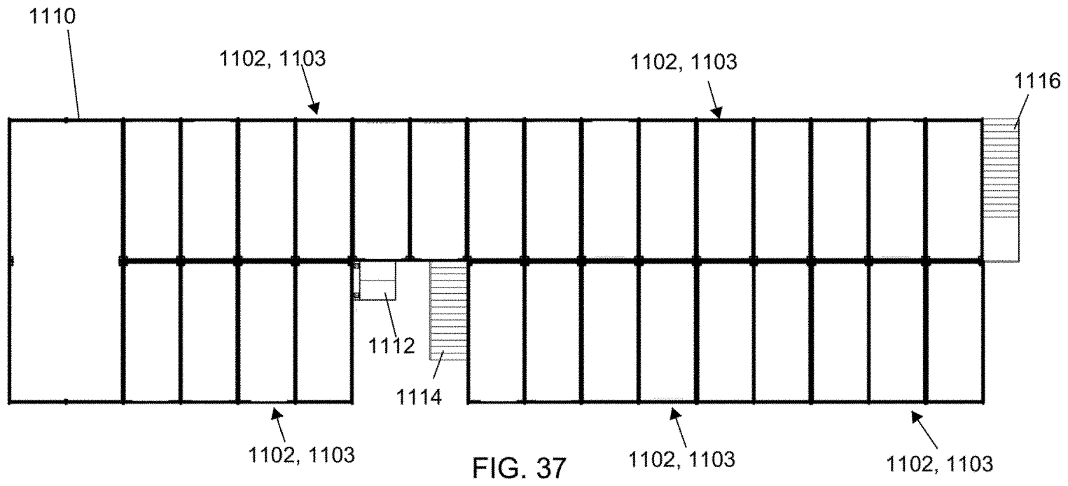

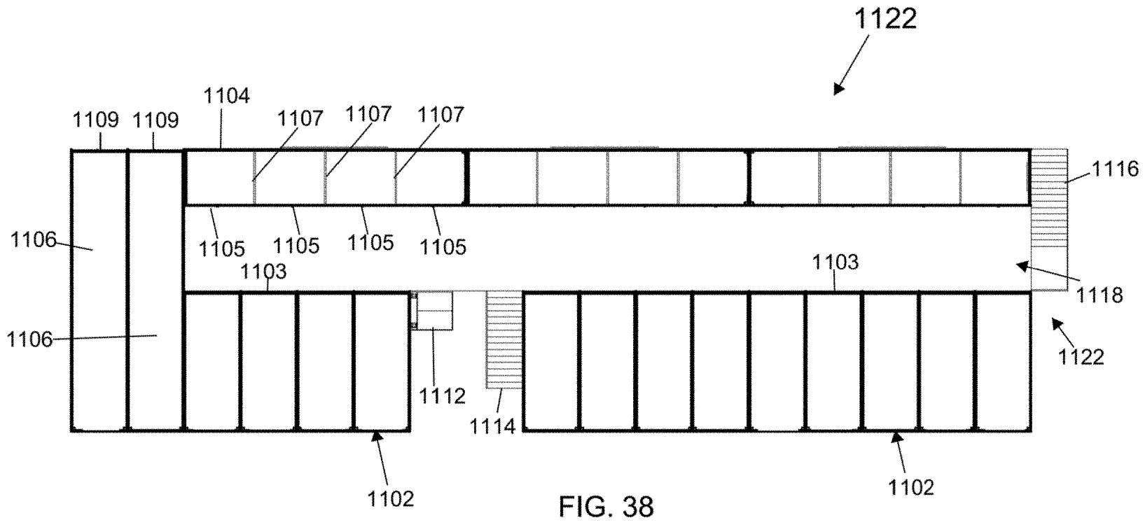

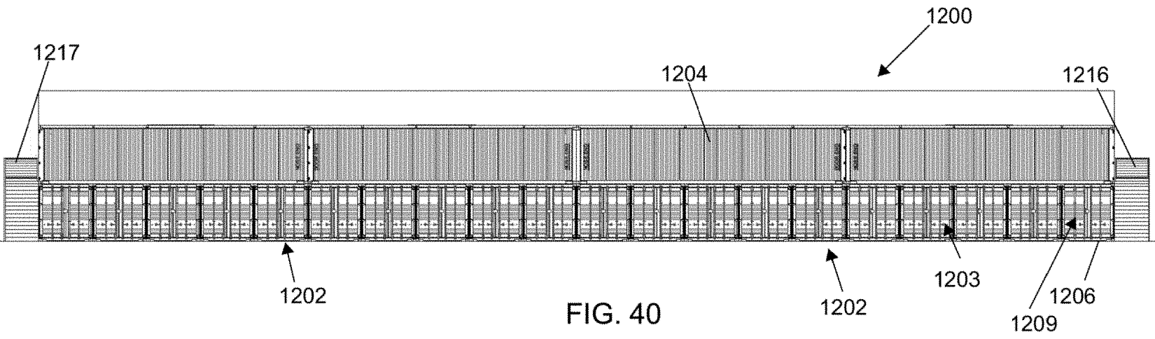

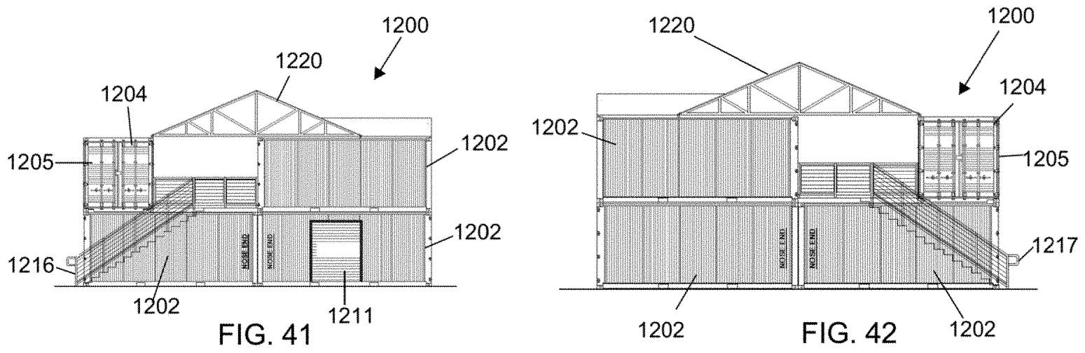

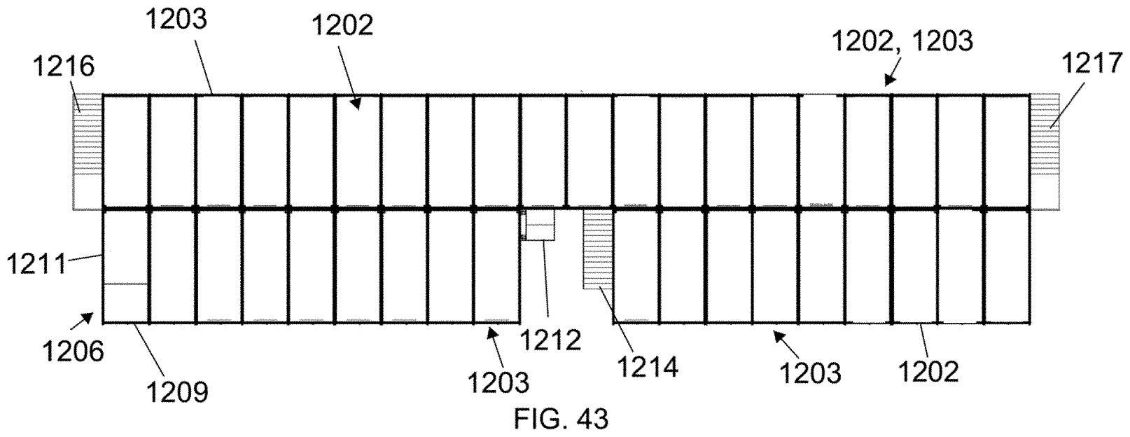

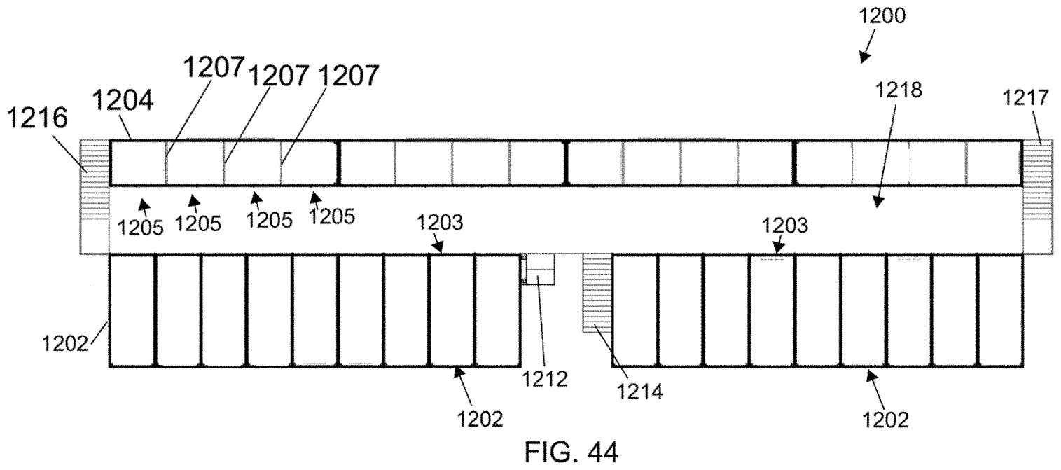

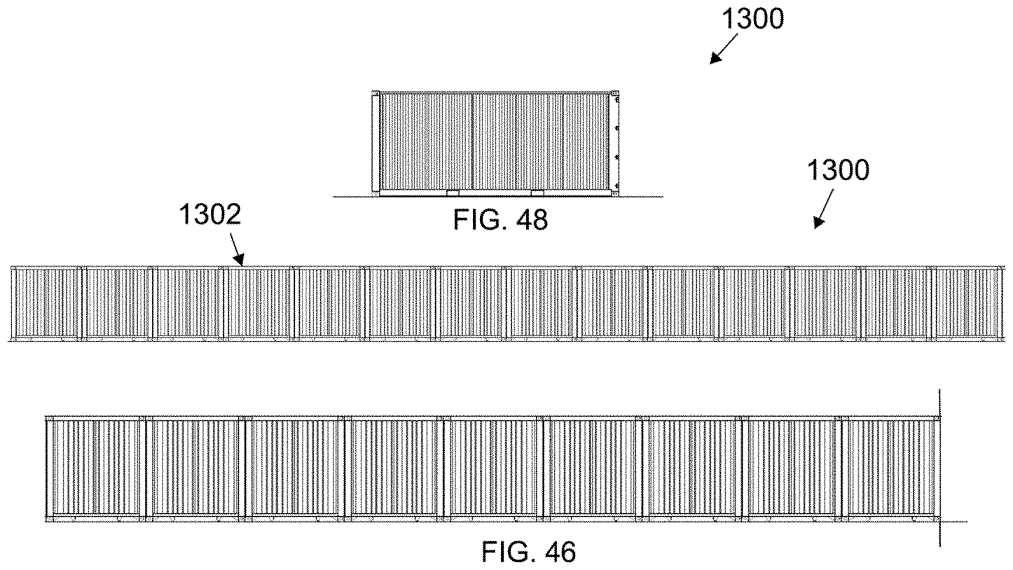

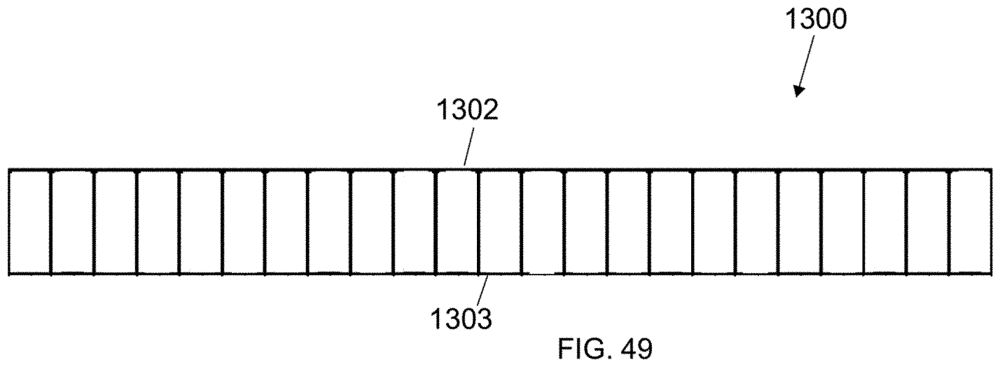

With reference now to the drawings, and in particular FIGS. 1-49, embodiments of the self-storage facilities of the present disclosure will be described.

FIG. 1 illustrates a storage facility 10 that includes a plurality of units 12, 14, 16, 18 that are arranged adjacent to each other, stacked on top of each other and/or abut each other. It is noted that for simplicity FIG. 1 is a side view of the storage facility 10 that depicts four units 12, 14, 16, 18. However, the number of units that are part of the storage facility 10 and the configuration of said units should not be limited to the number and/or configuration depicted in FIG. 1. Any number and any configuration of units can be utilized. That said, regardless of the number of units and size of units, as depicted in FIG. 1, the largest units (here units 12, 14) will be arranged at the base of the storage facility 10 on the ground level. The next largest units (here 16, 18) will be arranged on top of (stacked on) the largest units (units 12, 14). As shown, the largest lower units, units 12, 14, are arranged adjacent to each other with the other, the upper units, units 16, 18, are stacked on units 12, 14. Because units 16, 18 are smaller than units 12, 14, a portion of the roof 20, 22 of each of the units 12, 14, respectively, are utilized as a pathway/walkway 24 to provide access to the entrance 26, 28 of units 16, 18, respectively. The entrance 30, 32 of each base unit 12, 14 is shown at the exterior side of each respective unit 12, 14. While the entrance 30, 32 of each of the lower units 12, 14 are shown external to the facility 10, they could alternatively be arranged internal to the facility 10 if the units 12, 14 are spaced apart from each other.

The facility 10 can include a roof 34 that can be arranged above the uppermost level of the storage facility 10 (here above units 14 and 16) to protect customers/storage unit owners from the environments.

To access the stacked units 16, 18, a stairway or elevator or lift (not shown) can be utilized. In an embodiment, stairways can be attached to a side of each unit 12, 14, 16, 18 and aligned with an adjoining unit (i.e., the unit above or below). The lift or elevator of the storage unit 10 can be located internal of the facility 10. A consumer, for example, can drive into the storage facility and unload or load a vehicle with items to be stored or removed from storage near the lift. As such, this offers consumers the ability, like traditional drive-up storage facilities to easily store or retrieve items from storage. It is noted that the stacked units 16, 18 have entrances 26, 28 that face inward which eliminates the need to build an exterior walkway with a safety railing.

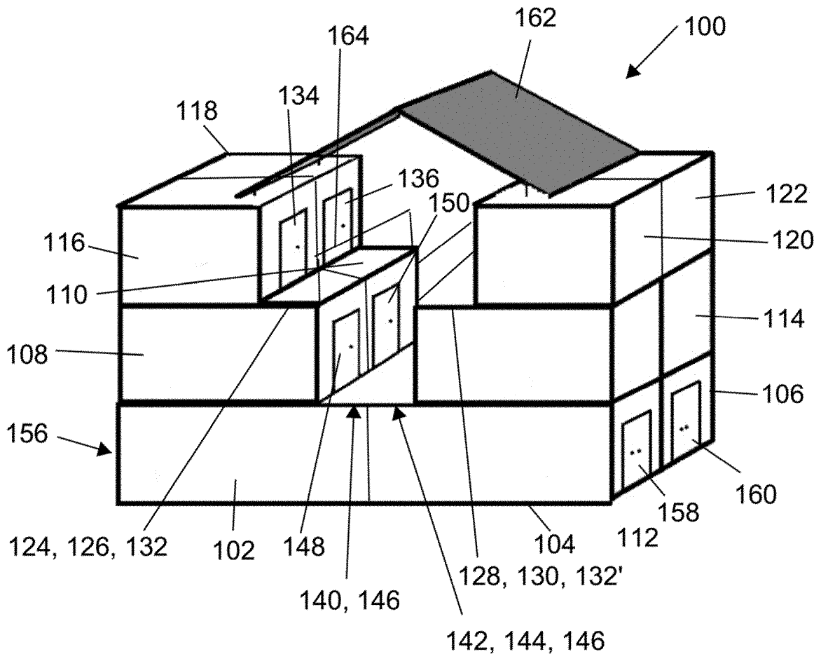

FIG. 2 depicts a storage facility 100 that includes a plurality of units 102-122 that are arranged adjacent to each other, stacked on top of each other and/or abut each other. It is noted that for simplicity that the FIG. 2 is a side view of the storage facility 100 that depicts eleven units. However, the number of units that are part of the storage facility 100 and the configuration of said units should not be limited to the number and/or configuration depicted in FIG. 2. Any number and any configuration of units can be utilized. That said, regardless of the number of units and size of units, as depicted in FIG. 2, the largest units (here units 102, 104, 106) will be arranged at the base of the storage facility 100 on the ground level. The next largest units (here 108-114) will be arranged on top of (stacked on) the largest units (units 102-106) and the smallest units (here 116-122) will be stacked on the second largest units (units 108-114).

As shown, the largest units, units 102, 104, 106, are arranged adjacent to each other with the second largest units, units 108, 110, 112, 114, stacked on the largest units 102, 104, 106. Because units 116-122 are smaller than units 108-114 and units 108-114 are smaller than units 102-106, a portion of each roof 124-130 of the second level of units 108-114, respectively, is utilized as a pathway/walkway 132, 132′ to provide access to the entrance 134-138 (only 134, 136 shown) of the upper level units 116-122, respectively, and a portion of the roof 140-144 of the lower level units 102-106, respectively, is utilized as a pathway/walkway 146 to provide access to the entrance 148-154 (152, 154 not shown), respectively, of the second level units 108-112. The entrance 156-160 of each base unit 102, 104, 106 are shown at the exterior sides of each respective unit 102, 104, 106. While the entrance of each of the units 102, 104, 106 is shown external to the facility 100, the entrances 156, 158, 160 could alternatively be arranged internal to the facility 100.

The facility 100 can further include a roof 162 that can be arranged above the uppermost level of the storage facility 100, here above units 116-122, to protect customers/storage unit owners from the environments. Further, a railing 164 can be provided, as necessary. For example, as shown in FIG. 2, the railing 164 can be arranged adjacent the outer edge of the roof roofs 124-130 of units 108-114, respectively, as a safety measure.

To access the stacked units 106-122 a stairway or elevator or lift (not shown) can be utilized. In an embodiment, stairways can be attached to a side of each unit 102-122 and aligned with an adjoining unit (i.e., the unit above or below). The lift or elevator of the storage unit 100 can be located internal of the facility 100. A consumer can drive into the storage facility 100 and unload or load a vehicle with items to be stored or removed from storage near the lift. As such, this offers consumers the ability, like traditional drive-up storage facilities to easily store or retrieve items from storage.

FIGS. 3-10 illustrate an embodiment of a self-storage facility 300 according to an embodiment of the present invention that includes a plurality of first storage units 302 that each have at least one door 303 that is configured to allow for access of the unit 302 that are arranged next to and stacked on top of each other. As shown, five twenty-foot long first storage units 302 are arranged next to each other and another five twenty-foot long first storage units 302 are stacked on top of the five base storage units 302. However, the units 302 can be of any desired length. Additionally, the storage facility 300 includes a plurality of second storage units 304, which each have at least one door 305 that is configured to access the unit 304, which are spaced from the first storage units 302 and are arranged adjacent to each other. A plurality of third storage units 306 that each have at least one door 307 can be stacked on top of the second storage units 304, are configured to be divided internally by a wall 309 into a first storage space 310 and a second storage space 312 that are associated with each storage space 310, 312.

The storage facility 300 can further include a floor 312 that extends between the first storage units 302 and second storage units 304 that are arranged on the first level of the facility 300 and a roof 314 that extends between the first and second level of the storage units 302, 304, 306 to create both a walkway to access the storage units 302, 306 on the second level and a roof to protect those walking between the units 302, 304 on the first floor from weather elements.

While FIGS. 3-10 depict a specific number of storage units 302, 304, 306, the present invention should not be limited to the configuration and arrangement shown in FIGS. 3-10 and any number or configuration or size of units can be combined to form the facility 300.

FIGS. 11-18 depict another embodiment of a storage facility 400. The facility 400 includes a plurality of first storage units 402 with doors 403 that abut each other and can be stacked upon each other. Additionally, a second storage units 404 with doors 405 are included that are stacked upon the first storage units 402. The second storage units 404 are divided internally into at least two internal spaces 406, 408 and 410, 412, respectively, by a divider 413. A portion of the roof of the first units 402 forms a walkway 414 for access to the second storage unit 404.

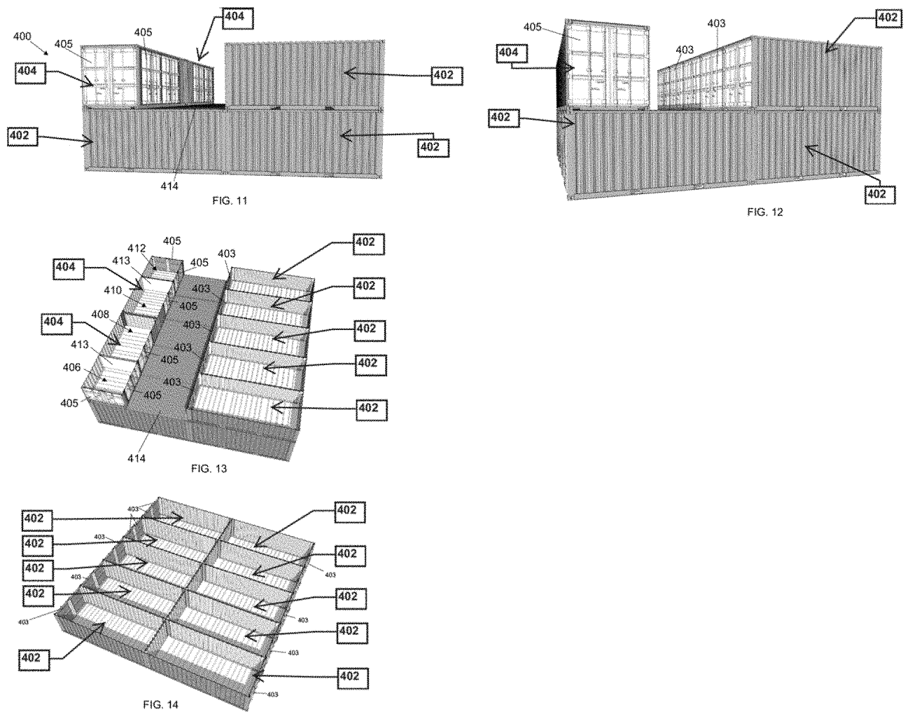

While FIGS. 10-18 depict a specific number of storage units 402, 404, the present invention should not be limited to the configuration and arrangement shown in FIGS. 10-18 and any number or configuration or size of units can be combined to form the facility 400.

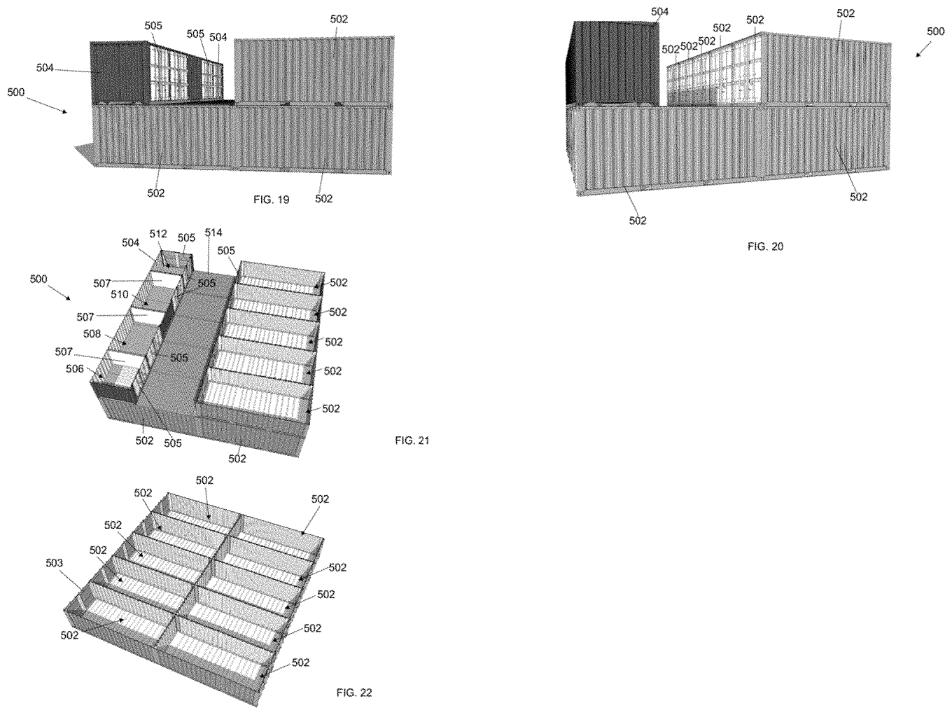

FIGS. 19-26 depict another embodiment of a storage facility 500. The facility 500 includes a plurality of first storage units 502 with doors 503 that abut each other and can be stacked upon each other. Additionally, a second storage units 504 with doors 505 is included that are stacked upon the first storage units 502. The second storage unit 504 is divided internally by walls 507 into four internal spaces 506, 508, 510, 512. A portion of the roof 514 of the first units 502 forms a walkway for access to the second storage unit 504.

While FIGS. 19-26 depict a storage facility 500 specific number of storage units, the present invention should not be limited to the configuration and arrangement shown in FIGS. 19-26 and any number or configuration or size of units can be combined to form the facility 500.

FIGS. 27-32D outline various storage facility configurations and types of containers.

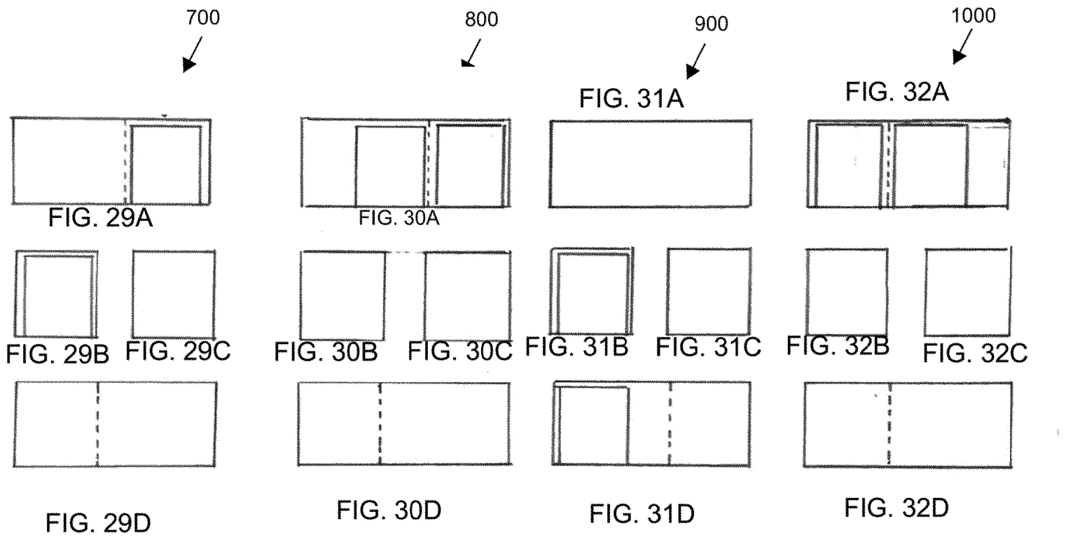

As can be seen in FIGS. 27, a storage facility 600 includes a plurality of containers that are stacked on top of each other. FIGS. 29A-32D depict various embodiments of containers 700, 800, 900, 1000 that can be incorporated into a facility to meet customer demand. The entrance to the containers 700, 800, 900, 1000 can be part of a sidewall or end wall of the container.

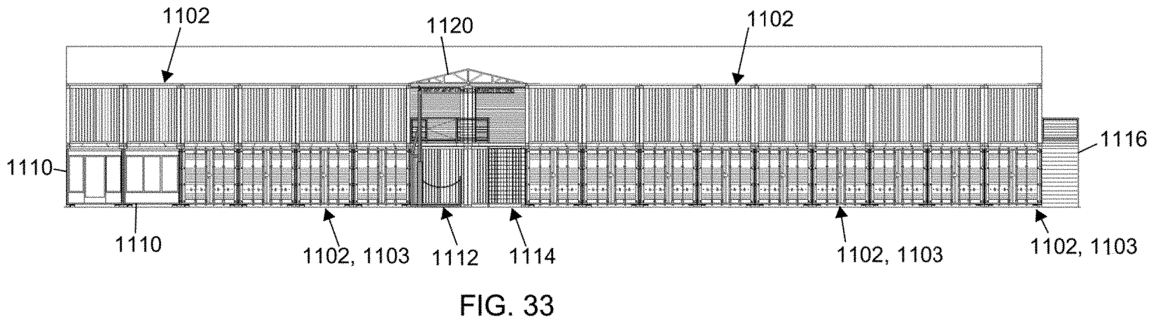

FIGS. 33-38 depict another embodiment of a storage facility 1100. The facility 1100, which has two levels, generally includes a plurality of first storage units 1102 with doors 1103 that abut each other and can be stacked upon each other, a plurality of second storage units 1104 with doors 1105 that abut each other and can be subdivided internally into a plurality of cavities by dividers 1107, a plurality of third storage units 1106 with doors 1109, a storefront 1110, a hydraulic lift 1112 and a plurality of staircases 1114, 1116.

The first level or ground floor 1121 includes a first plurality of the first storage units 1102 arranged adjacent to each other, second plurality of the first storage units 1102 abutting a portion of the first plurality of the first storage units 1102, a third plurality of the first storage units 1102 are spaced from the second plurality of the first storage units 1102 and abut another portion of the first plurality of the first storage units 1102. Additionally, the storefront is arranged adjacent the first and second plurality of first storage units 1102.

The second level 1122 includes a fourth plurality of the first storage units 1102 stacked upon the second plurality of first storage units 1102 and a fifth plurality of the first storage units 1102 that are stacked upon the third plurality of first storage units 1102. The plurality of second storage units 1104 are spaced from the fourth and fifth plurality of the first storage units 1102 by a corridor 1118. The plurality of third storage units 1106 extend, as can be seen in FIG. 38, the entire width of the facility 1100 adjacent to one of the fourth plurality of the first storage units 1102 and one of the plurality of the second storage units 1104.

Arranged between the second and third and fourth and fifth plurality of the first storage units 1102 is the hydraulic lift 1112 and a first staircase 1114.

As can be seen in FIGS. 33, 35 and 36, a roof 1120 can extend over at least the lift 1112 and staircase 1114. A second staircase 1116 is arranged adjacent an end of the facility 1100, opposite the storefront 1110 to further allow for access to the second level of the facility 1100.

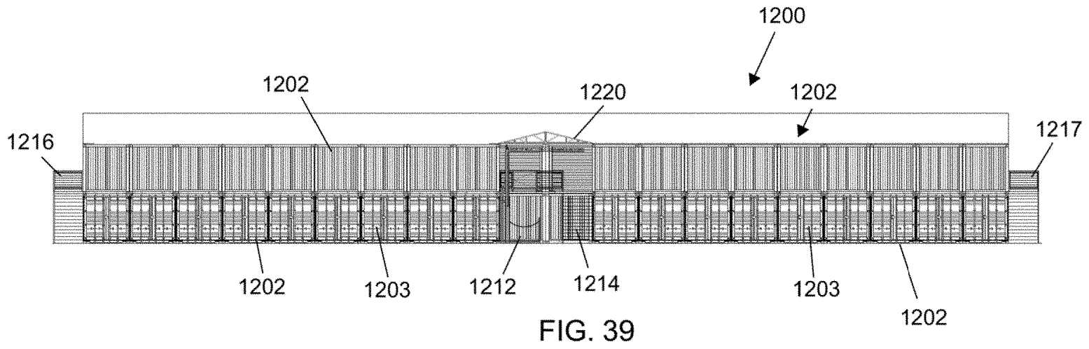

FIGS. 39-44 depict yet another embodiment of a storage facility 1200. The facility 1200, which has two levels, generally includes a plurality of first storage units 1202 with doors 1203 that abut each other and can be stacked upon each other, a plurality of second storage units 1204 with doors 1205 that abut each other and can be subdivided internally into a plurality of cavities by dividers 1207, at least one third storage units 1206 with doors 1209, 1211, a hydraulic lift 1212 and a plurality of staircases 1214, 1216, 1217.

The first level, or ground floor, 1221 includes a first plurality of the first storage units 1202 arranged adjacent to each other, second plurality of the first storage units 1202 abutting a portion of the first plurality of the first storage units 1202, a third plurality of the first storage units 1202 are spaced from the second plurality of the first storage units 1202 and abut another portion of the first plurality of the first storage units 1202. Additionally, the third storage unit 1206 is arranged adjacent the second plurality of first storage units 1202.

The second level 1222 includes a fourth plurality of the first storage units 1202 stacked upon the second plurality of first storage units 1202 and a fifth plurality of the first storage units 1202 that are stacked upon the third plurality of first storage units 1202. The plurality of second storage units 1204 are spaced from the fourth and fifth plurality of the first storage units 1202 by a corridor 1218.

Arranged between the second and third and fourth and fifth plurality of the first storage units 1202 is the hydraulic lift 1212 and a first staircase 1214.

As can be seen in FIGS. 33, 35 and 36, a roof 1220 can extend over at least the lift 1212 and staircase 1214. A second staircase 1216 is arranged adjacent a first end of the facility 1200, and a third staircase 1217 is arranged adjacent a second end of the facility 1200 to further allow for access to the second level of the facility 1200.

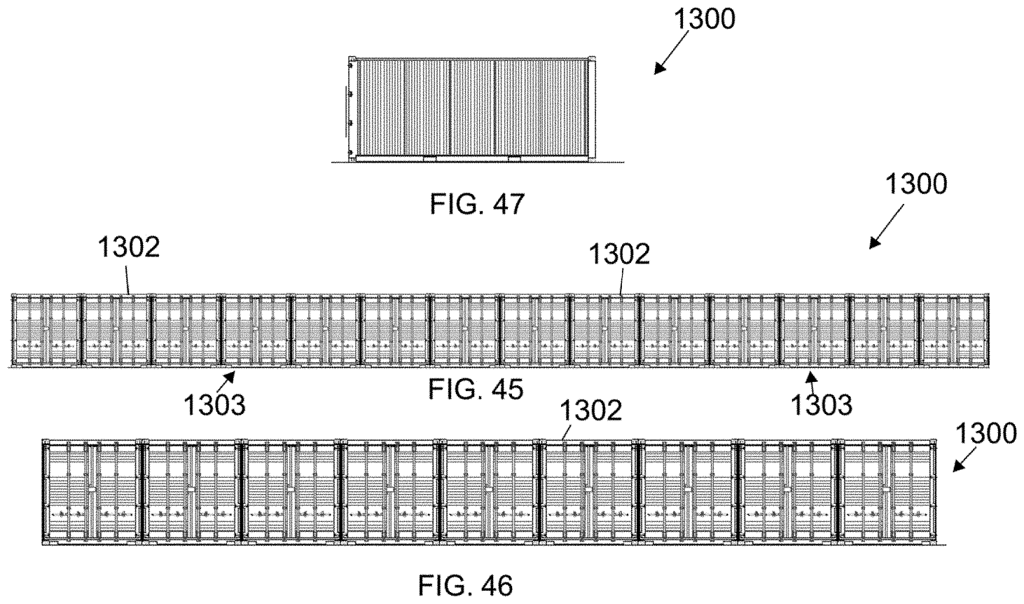

FIGS. 45-49 depict yet a further facility 1300. Here, the facility 1300 is a single level facility that includes a plurality of identical storage units 1302 arranged adjacent to each other that include doors 1303 to access the units 1302.

It is noted that in all embodiments, the facilities are scalable and as such there can be any number of units included therein. As such, regardless of configuration, by using standard shipping containers (e.g., twenty-foot and/or forty-foot) and either aligning the containers next to each other, reconfiguring the container doors and/or reconfiguring the space inside the container(s) to create a plurality of storage spaces within a shipping container, a modular storage facility can be created.

Although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. It is to be understood that the phraseology or terminology employed herein is for the purpose of description and not of limitation. In addition, while several variations of the embodiments of the invention have been shown and described in detail, other modifications, which are within the scope of this invention, including, but not limited to, the substitutions of equivalent features, materials, or parts, will be readily apparent to those of skill in the art based upon this disclosure without departing from the spirit and scope of the invention.

What is claimed is:

1. A self-stage facility, comprising:
a plurality of storage units that are arrangeable one of adjacent to each other and stacked on top of each other.

2. The self-stage facility of claim 1, wherein the plurality of storage units includes at least first storage units of a first length and width and second storage units of a second length and second width.

3. The self-stage facility of claim 1, wherein at least two of the first storage units are arranged adjacent to each other on a ground level and the second storage units are one of spaced from the first storage unit and stacked on the first storage units.

4. The self-stage facility of claim 1, wherein a roof can extend over a space between storage units.

5. The self-stage facility of claim 1, further comprising one of a lift and elevator.

6. The self-stage facility of claim 1, further comprising a storefront

7. The self-stage facility of claim 1, further comprising a plurality of staircases.

8. The self-stage facility of claim 1, wherein the storage units each include a plurality of doors to access the units.

9. The self-stage facility of claim 1, wherein the plurality of storage units includes at least first storage units and second storage units that are one of spaced from each other and abut each other.

10. The self-stage facility of claim 1, wherein the storage units can be subdivided internally with access to the inside of each subdivision by a separate door.

11. A method of assembling a self-storage facility, the method including:
providing a plurality of first storage units of a first length and width and a plurality of second storage units of a second length and width;
arranging the first storage units adjacent to each other on a ground level;
arranging the second storage units one of spaced from the first storage units on the ground level and stacked on the first units.

12. The method of claim 8, further comprising the step of removing at least one of said first storage units and said second storage units and replacing said unit with another unit.
